(19) United States
(12) Patent Application Publication
(10) Pub. No.: US 2019/0255717 A1
(43) Pub. Date: Aug. 22, 2019

(54) KNIFE BLADE AND METHOD FOR MAKING SAME

(71) Applicant: Stephen Pustilnik, Houston, TX (US)

(72) Inventor: Stephen Pustilnik, Houston, TX (US)

(21) Appl. No.: 15/902,214

(22) Filed: Feb. 22, 2018

(51) Int. Cl. B26B 9/02

(52) U.S. Cl. CPC B26B 9/02

(57) ABSTRACT

A knife blade with a spine portion and a blade portion is disclosed wherein the blade portion is formed from opposed first and second planar surfaces terminating in an edge portion. The spine portion and first planar surface form the legs and the second planar surface forms the hypotenuse of a right triangle. The first planar surface may form a first angle with the spine portion of about 90°. About 30% of the second planar surface may be parallel to the first planar surface and form a second angle with the spine of about 90°. The spine portion may also have a vector extending from the spine portion to the edge portion and adjacent to the concave surface to form the legs of a right triangle and the planar surface forms the hypotenuse of a right triangle.

### RELATED APPLICATIONS

None.

### FIELD

The invention relates generally to knife blades and more particularly with the construction of and the method for making knife blades that reduce resistance on the blade edge when in use.

### BACKGROUND

A knife generally has two parts, the blade and the handle. The grind of the blade refers to the cross-sectional shape of the blade. Grinding a knife blade involves removing significant portions of metal from the blade creating the cross-sectional shape of the blade. The cross section of the blade reflects its general use.

There are several types of grinds known in the prior art. For example, a hollow grind is concave such that the two planar sides curve inward until they meet at their terminal edge. Another example is a balanced grind that begins tapering to the terminal edge from the spine on both sides. A final example is a chisel grind, which is completely flat on one side from the spine to the terminal edge and the other side has a single bevel that starts around the middle of the blade. It then tapers in a straight line toward the edge.

It is possible to construct a mathematical blade of infinite thinness, i.e. being immeasurably small, and it will cut through items without any resistance. Once the spine of a blade has any sort of thickness, it will produce resistance when in use. As the blade gets thicker, the more force is felt when in use. It would be useful to have a knife blade and method for grinding a knife blade that would work for any blade of any width or thickness and that reduces the amount of resistance felt when in use when compared to traditional knife blades and methods for grinding knife blades.

### BRIEF SUMMARY OF THE INVENTION

It is the object of the present invention to provide a knife blade and method for grinding a knife blade that outperforms traditional knife grinding edges of similar height and spine thickness. A first embodiment of the present invention is a knife blade and method for making same wherein the knife blade has a spine portion and a blade portion. The blade portion is formed from opposed first and second planar surfaces terminating in an edge portion. The spine portion and first planar surface form the legs and the second planar surface forms the hypotenuse of a right triangle.

In a second embodiment, a knife blade and method for making same wherein the knife blade has a spine portion and a blade portion with opposed concave and planar surfaces terminating in an edge portion. The spine portion and a vector extending from the spine portion to the edge portion and adjacent to the concave surface form the legs of a right triangle. The planar surface forms the hypotenuse of a right triangle.

In a third embodiment, a knife blade and method for making same wherein the knife blade has a spine portion and a blade portion that has first and second planar surfaces terminating in an edge portion. The first planar surface forms a first angle with the spine portion of about 90°. About about 30% of the second planar surface is parallel to the first planar surface and forms a second angle with the spine of about 90°.

In a fourth embodiment, a knife blade and method for making same wherein the knife blade has a spine portion and a blade portion with opposed concave and planar surfaces terminating in an edge portion. A vector extends from the spine portion to the edge portion and adjacent to the concave surface. The vector and spine portion forms a first angle of about 90°. About 30% of the planar surface is parallel to the vector and forms a second angle with the spine portion of about 90°.

### BRIEF DESCRIPTION OF THE DRAWINGS

FIG. 1 is a cross-section of a blade of the prior art.

FIG. 2 is a cross-section of an embodiment of the blade of the present invention.

FIG. 3 is a cross-section of an embodiment of the blade of the present invention.

FIG. 4 is a cross section of a blade of the prior art with the edge inserted into a material to be cut by the blade.

FIG. 5 is a cross section of the blade of an embodiment of the present invention inserted into a material to be cut by the blade.

FIG. 6 is cross section of an embodiment of the blade of the present invention.

FIG. 7 is a cross section of a blade of the prior art.

FIG. 8 is a cross section of an embodiment of the blade of the present invention.

FIG. 9 is a cross section of an embodiment of the blade of the present invention.

FIG. 10 is a cross section of an embodiment of the blade of the present invention.

FIG. 11 is a cross section of an embodiment of the blade of the present invention.

FIG. 12 is a cross section of an embodiment of the blade of the present invention.

FIG. 13 is a cross section of an embodiment of the blade of the present invention.

FIG. 14 is a cross section of an embodiment of the blade of the present invention.

FIG. 15 is a side view of an embodiment of the blade of the present invention.

### DETAILED DESCRIPTION

Knife blades of the prior art have typically used a shinogi surface and/or a urasuki. The shinogi surface is known as the flat surface of the blade that runs to the blade's edge in a single-bevel knife. This flat surface allows for a narrow blade angle, resulting in a sharper knife. The urasuki is the concave surface on the backside of the blade that creates an air pocket when the blade is slicing through food. This helps to reduce drag and creates a smoother surface, so you can make faster, nicer cuts. It also works to prevent the food from sticking to the knife. The goal is for the blade to cut food with very minimal damage to the surface and cells, therefore not spoiling the texture, taste and presentation.

The present invention serves to cut down amount of resistance on blade by about 50%, making the knife blade more efficient to get a cleaner cut.

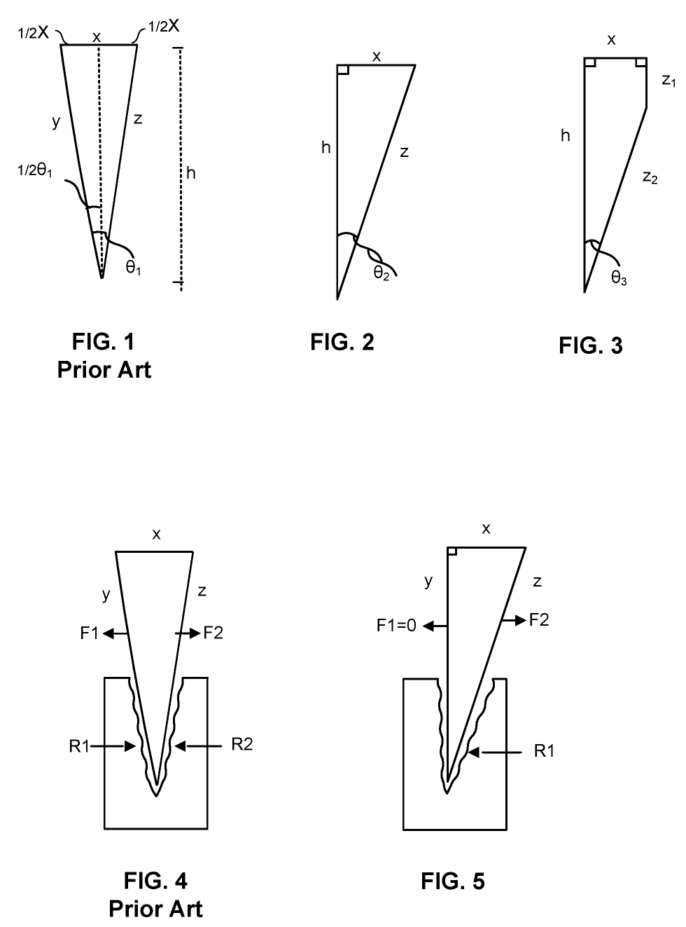

Turning to FIG. 1, the cross section of a traditional knife blade known in the prior art is shown wherein two planar sides “y” and “z” extend from a spine “x” with a height “h” and angle θ₁ between sides y and z.

Turning to FIG. 2, the cross section of one embodiment of the knife blade of the present invention is shown wherein two side “h” and “z” extend from a spine “x” with a height corresponding to side “h.” A right angle is formed between side h and spine x and angle θ₂ between sides h and z.

Looking at the FIG. 1, it is important to note that for western knives (isosceles triangle) where theta is the angle of the cutting edge and the spine of the knife is 2 mm wide and the height of the blade is 50 mm:

tan ½ θ=1/50

tan ½ θ=0.02

½ θ=tan⁻¹ 0.02

½ θ=1.14576°

One must double ½ θ to get the angle of the cutting edge: 2×½ θ=2.29153°

For the blade geometry of the present invention shown in FIG. 2 with a 2 mm wide spine and 50 mm high blade and angle of the cutting edge is alpha (or θ₂ on FIG. 2)

tan α=2/50

tan α=0.04

α=tan⁻¹ 0.04

α=2.29061°

Therefore, the angle of the cutting edge of the knife of the present invention geometry is always more acute than the cutting edge angle of the traditional western isosceles triangle cross sectional geometry when comparing blades of the same height and spine thickness.

Turing to FIG. 3, a cross section of a second embodiment of the knife blade of the present invention is shown one side angling upward towards the spine “x” to form two segments “z₁” and z₂” wherein z₂ is about 70% of the side. A second side “h” extending from the spine x. A right angle is formed between side h and spine x as well as between side z₁ and spine x with angle θ₃ between sides h and z₂.

Turning to FIG. 4, a cross section of a knife blade of the prior art of FIG. 1 is shown inserted into a material being cut by the knife blade. There is a resistance “R1” against the material that generates a force “F1” on side “y” and a resistance “R2” against the material which generates a force “F2” on side “z.”

Turning to FIG. 5, a cross section of one embodiment of the knife blade of the present invention is shown inserted into a material being cut by the knife blade. It is noted that the there is only one resistance “R1” that generates force “F2” along side “z.” As such, force along side “y” is zero.

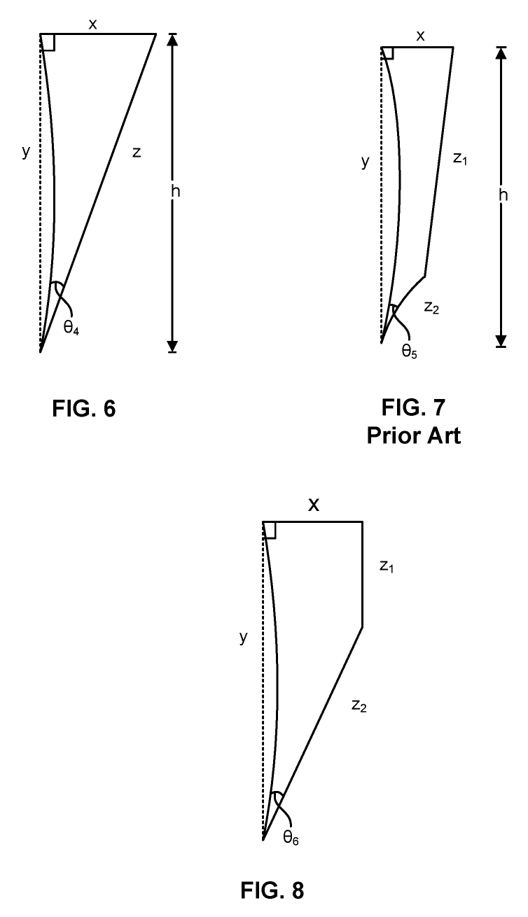

Turning to FIG. 7, the prior art knife blade is shown with a urasaki and a shinogi side. The urasaki can be applied to the present invention to create an air pocket to reduce drag when making cuts, as shown in FIGS. 6 and 8.

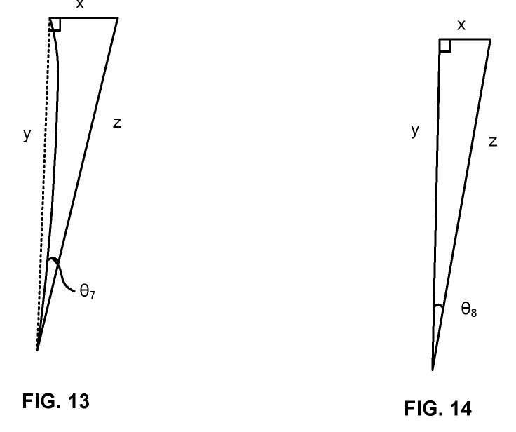

As shown in FIG. 13, use of the urasaki with the present invention creates an even more acute angle θ₇ when compared to θ₈ of FIG. 14, which increases knife blade performance.

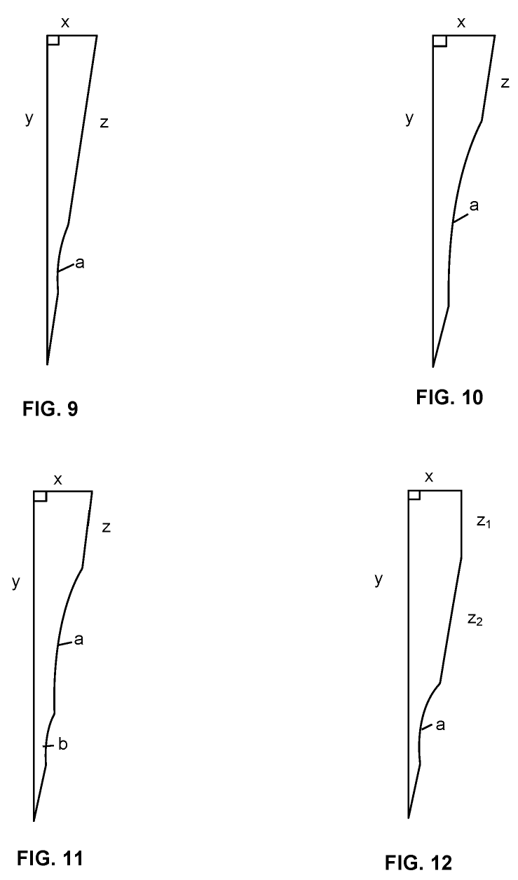

Additionally, the various configurations of rounded or beveled groove or slots in the flat side of a blade, known as fullers, can be used with the knife blade of the present invention as shown in FIGS. 9-12. The fuller creates an air gap between the food product and the blade surface that promotes the release of the food slice from the blade surface and it drops onto the cutting board rather than rising up the height of the blade to the tip of the spine and rolling away from the knife in an uncontrolled manner. The fuller allows each slice of food to remain in place with the prior slices of food in an organized manner. It should also be noted that the curve portion “a” in FIG. 10 may also curve outward forming a convex shape.

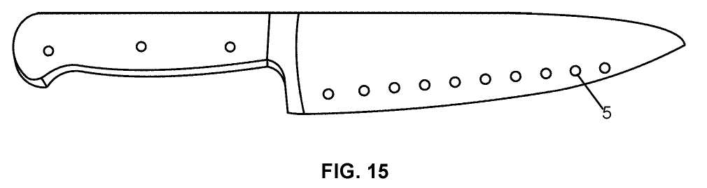

Finally, as shown in FIG. 15, fenestrations may extend through the edge of the knife blade. The fenestration is another method of creating an air gap between the food slice and the blade surface for more efficient food release from the blade to keep each slice in place with prior slices in an organized fashion.

Further, any one of the embodiments shown herein may have fenestrations as a part of the blade and any style of grip known in the prior art, including, but not limited to a kellum grip.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

1. A knife blade comprising:
a. a spine portion; and
b. a blade portion including opposed first and second planar surfaces terminating in an edge portion;
wherein the spine portion and first planar surface form the legs and the second planar surface forms the hypotenuse of a right triangle.

2. The knife blade of claim 1 wherein the second planar surface has at least one groove extending horizontally along a portion of a length of the second planar surface.

3. The knife blade of claim 1 further comprising at least one scalloped indentation in the first or second planar surfaces.

4. The knife blade of claim 2 further comprising at least one scalloped indentation in the first or second planar surfaces.

5. The knife blade of claim 1 further comprising at least one fenestration extending through the blade portion from the first planar surface to the second planar surface.

6. The knife blade of claim 1 wherein the edge portion is serrated.

7. A knife blade comprising:
a. a spine portion; and
b. a blade portion including opposed concave and planar surfaces or opposed convex and planar terminating in an edge portion;
wherein the spine portion and a vector extending from the spine portion to the edge portion and adjacent to the concave or convex surface form the legs; and
wherein the planar surface forms the hypotenuse of a right triangle.

8. The knife blade of claim 7 wherein the planar surface has at least one groove extending horizontally along a portion of a length of the planar surface.

9. The knife blade of claim 7 further comprising at least one scalloped indentation in the concave or planar surfaces.

10. The knife blade of claim 8 further comprising at least one scalloped indentation in the concave, convex or planar surfaces.

11. The knife blade of claim 7 wherein the edge portion is serrated.

12. The knife blade of claim 7 further comprising at least one fenestration extending through the blade portion from the first planar surface to the second planar surface.

13. A knife blade comprising:
a. a spine portion;
b. a first side, said first side comprising a first side spine edge, a first side surface, a first side cutting edge, and a first side height wherein said first side spine edge comprises the junction of said spine portion and said first side; wherein said first side surface comprise an area located between said first side spine edge and said first side cutting edge; wherein said first side surface comprises a first side plane; and said first side height comprises the shortest distance between said first side spine edge and said first side cutting edge at any given point along said first side;
c. a second side, said second side comprising a second side spine edge, a top planar surface, a top planar surface height, a planar transition point, a bottom beveled planar surface, and a second side cutting edge; wherein said second side spine edge comprises the junction of said spine portion and said top planar surface of said second side; wherein said top planar surface of said second side comprises a second side top plane; wherein said top planar surface of said second side comprises a portion of said second side located between said second spine edge and said planar transition point wherein said top planar surface height comprises the shortest distance between said second side spine edge and said planar transition point at any given point along said second side; wherein said bottom beveled planar surface of said second side comprises a portion of said second side located between said planar transition point and said second side cutting edge; and wherein said bottom beveled planar surface of said second side comprises a second side bottom plane, wherein said second side bottom plane forms an angle with said second side top plane such that said second side bottom plane intersects both said second side top plane and said first side plane;
wherein, at a point along said knife blade, said top planar surface height is less than or equal to 30% of said first side height.

14. The knife blade of claim 13 wherein the second planar surface has at least one groove extending horizontally along a portion of a length of the second planar surface.

15. The knife blade of claim 13 further comprising at least one scalloped indentation in the first or second planar surfaces.

16. The knife blade of claim 14 further comprising at least one scalloped indentation in the first or second planar surfaces.

17. The knife blade of claim 13 further comprising at least one fenestration extending through the blade portion from the first planar surface to the second planar surface.

18. (canceled)

19. A knife blade comprising:
a. a spine portion; and
b. a blade portion including opposed concave and planar surfaces or opposed convex and planar surface terminating in an edge portion;
wherein a vector extends from the spine portion to the edge portion and adjacent to the concave surface;
wherein the vector and spine portion forms a first angle of about 90°; and
wherein about 30% of the planar surface is parallel to the vector and forms a second angle with the spine portion of about 90°.

20. The knife blade of claim 19 wherein the planar surface has at least one groove extending horizontally along a portion of a length of the planar surface.

21. The knife blade of claim 19 further comprising at least one scalloped indentation in the concave, convex or planar surfaces.

22. The knife blade of claim 20 further comprising at least one scalloped indentation in the concave, convex or planar surfaces.

23. The knife blade of claim 19 wherein the edge portion is serrated.

24. The knife blade of claim 19 further comprising at least one fenestration extending through the blade portion from the first planar surface to the second planar surface.
